(19) United States
(12) Patent Application Publication
(10) Pub. No.: US 2012/0135223 A1
(43) Pub. Date: May 31, 2012

(54) METHOD FOR DETACHABLE GLUING FOR POROUS MATERIALS

(76) Inventors: Jose Alcorta, Begles (FR); Maxime Olive, Talence (FR); Guy Larnac, Saint Aubain de Medoc (FR); Evelyne Chataignier, Saint Medard En Jalles (FR)

(21) Appl. No.: 13/257,276

(22) PCT Filed: Mar. 5, 2010
(86) PCT No.: PCT/EP2010/052839

§ 371 Date: Feb. 17, 2012

(30) Foreign Application Priority Data
Sep. 23, 2010 (FR) 0951692

(51) Int. Cl. B32B 7/06; B32B 38/08; B32B 3/26; B32B 37/12

(52) U.S. Cl. 428/317.1; 156/60; 156/151

(57) ABSTRACT

A method for detachably gluing at least one porous substrate to another material using at least one layer of a detachable adhesive comprising an ungluing admixture adapted for generating gases which, by gas expansion or gas migration towards at least one of the interfaces of the detachable adhesive layer, weakens the adhesive bond when heated by a detaching control, the aforementioned method including, before gluing, applying a metal sealing coating onto at least one of the substrates.

### CROSS-REFERENCE TO RELATED APPLICATIONS

This application is the National Stage of International Application No. PCT/EP2010/052839 International Filing Date, 5 Mar. 2010, which designated the United States of America, and which International Application was published under PCT Article 21 (s) as WO Publication No. WO2010/105924 A1 and which claims priority from, and the benefit of, French Application No. 0951692 filed on 17 Mar. 2009, the disclosures of which are incorporated herein by reference in their entireties.

### BACKGROUND

The disclosed embodiments relate to a method for detachable gluing for porous materials.

It applies particularly in the field of structural gluing and more particularly that of gluing that is detachable when desired to enable disassembly or dismantling of structures during their lifetimes or at the end of their lives.

The industrial sectors involved in particular are the sectors that use composite materials such as aerospace, aeronautics, automobiles, wind power, or other sectors for which large-size structures are made of composite materials.

In the case of space launchers, the method of the disclosed embodiments is especially useful for the design of separable-stage launchers.

Methods of gluing that permit controlled detachment as are disclosed in particular in the documents FR 2 837 114 A1, WO2004/087829 A2, and WO2006/048585 A1.

A particular method is also known from the publications IN72-AM, N, BT, and JC of Engineering Technology.

The technique described in the documents FR 2 837 114 A1 and WO2004/087829 A2 consists of incorporating in an adhesive or in an adhesion primer an additive that can generate gases that can be caused to expand by heating.

In the document WO2006/048585 A1, the additive is a product that migrates to the interface under the action of heat to generate a low-cohesion coating, particularly by migration of gas and the creation of interfacial constraints.

It is a problem that the method of detachment due to heating leading to migration of an additive to the substrate/adhesive interface accompanied by a gaseous expansion at this interface functions with variable efficacy depending on the glued substrates.

More particularly, the detachment can be improved when the substrates are porous, whether they are wooden or made of composite materials or materials obtained by sintering.

It has been found, as in any structural glue joint, that when the films of glue and/or of primers used are very thin, at the time of controlled degassing, the gases diffuse very easily through these films and then to the exterior, especially through porous substrates.

Because of this, the creation of a pocket of gas enabling the degradation of the glued bond cannot occur at the adhesive/substrate interface, which makes the process ineffective.

Increasing the thickness of the films of glue and/or the amount of additive and accordingly of the gases generated is not satisfactory since it is incompatible with structural gluing.

### SUMMARY

To solve this problem, the disclosed embodiments propose a solution allowing the glue joint to keep adhesion in use close to that obtained when using a structural glue joint of the same substrates without means of controlled detachment, while allowing a low residual adhesion of the glue joint after the ungluing action.

To accomplish this, the disclosed embodiments propose a method for detachable gluing of at least one porous substrate with another material by means of at least one layer of detachable adhesive that contains an ungluing additive able to generate gases that disrupt an adhesive bond by gaseous expansion or by gaseous migration to at least one of the interfaces of the layer of detachable adhesive under the action of heat for controlled detachment, for which a metallic seal lining is applied to the said at least one substrate prior to the gluing.

It is advantageous for said layer of detachable adhesive to have a layer of detachable primer and a layer of adhesive.

According to a first embodiment, the metallic lining is produced by means of a strip glued to said at least one substrate by means of a composite/metal coupling adhesive.

Alternatively, the metallic lining is produced by means of a strip glued to said at least one substrate by fusing them together.

The strip is particularly a strip of aluminum.

The strip is advantageously coated with the detachable adhesive layer prior to its application to said at least one substrate.

According to a second embodiment, the metallic lining is produced by metal deposition.

According to a first variant, the metal deposition is accomplished by electroplating.

In this mode, a layer of copper is preferably deposited on said substrate.

The metal lining is advantageously concluded by the deposition of a layer of nickel on the layer of copper.

According to a second variant, the metal deposition is accomplished by a physical metal vapor phase deposition technique.

The metal is preferably chosen from aluminum, titanium, and a nickel/chromium alloy.

The metallic lining is advantageously produced by the deposition of a layer of metal from 1 to 10 microns in thickness.

According to a preferred embodiment, the metallic lining is produced by the deposition of a layer of titanium from 1 to 3 microns in thickness.

According to a third variant, the metallic deposition is performed by flame-projection metallization.

The metal in this case is preferably chosen from aluminum, titanium, and a nickel/chromium alloy.

According to an advantageous embodiment of the disclosed embodiments, in the case of a deposition, a stripping operation is preferably performed on the substrate prior to the deposition.

The stripping operation is advantageously performed with argon atoms, and preferably with a mixture of argon and oxygen atoms.

According to a preferred embodiment, the surface of the metallic lining is polished after deposition and before application of the detachable adhesive and gluing, to reduce the roughness Ra of the lining.

Always in the context of the disclosed embodiments, at least either the thickness of the metallic lining or roughness of the metallic lining is advantageously adapted to obtain a breaking strength between 10 and 20 MPa before the detachment action and a breaking strength of less than 1 Mpa after the detachment action.

The disclosed embodiments also relate to a detachable assembly of at least one porous substrate with another material produced by means of a method of detachable gluing for which the strength of the assembly before the detachment action is greater than 15 Mpa with cohesive rupture between the substrate and the lining, and the residual strength after the detachment action is below 0.8 Mpa.

In the case of the procedure of the disclosed embodiments using a strip, the assembly preferably includes the following: a first composite substrate, a composite/metal coupling adhesive, a metallic lining, a layer of detachable primer, a layer of adhesive, and a second substrate.

The assembly according to the method of the disclosed embodiments is advantageously such that the metallic lining makes an electrically conductive zone beneath the detachable primer and constitutes a conductive resistive pathway able to control the detachability of the bond by the passage of an electric current in the metallic lining to heat the bonding zone by a Joule effect.

Other characteristics and benefits of the disclosed embodiments will be apparent from reading the following description of non-limiting forms of embodiment.

### DETAILED DESCRIPTION

The disclosed embodiments apply very particularly to structural assemblies, in other words to assemblies produced with high-strength mechanical bonds intended to function for lengths of time that can be very long.

Examples of such bonds are the fastening of windshields to automobile bodies, bonds between stages of launchers or space probes, or assemblies of composite structures, fuselage or wing panels of aircraft, or blades of wind turbines.

It is applicable when the separation of the elements of the assemblies is to be controlled, in other words initiated in a controlled manner, and is to lead to a minimal shear force.

In this context, the disclosed embodiments propose a method for detachably gluing at least one porous substrate to another material, wherein this other material may itself be a porous substrate or not.

The document WO2004/087829 A2 describes in particular the measurement methods used and the order of magnitude of the mechanical strengths expected. These strengths actually depend on the system that is assembled, but for the aspect of detachability the residual strength must not exceed 1 Mpa.

The disclosed embodiments thus proposes an improvement of the procedure as described in the documents cited above so that this procedure retains its efficacy for use with porous substrates.

This improvement must allow the glued joint to retain a strength in use close to that obtained from a structural glue joint of the same substrates, while permitting a low residual strength after action.

The solution proposed by the disclosed embodiments and tested in particular on carbon-epoxy composites, is to line at least one of the surfaces to be glued by metallization, adapting this metallization process so that this metallization has sufficient adhesion to the substrate, in other words adhesion at least equivalent to the strength of the glued bond.

The disclosed embodiments function in the case of two porous substrates together, and if the additive is incorporated in a primer, it is sufficient to line one of the porous substrates such as a composite by the metallic lining of the side on which is located the primer with additive, with the adhesive on the side of the second porous substrate itself forming a sealer film.

If the additive is incorporated in the adhesive, it may be preferable to line the two porous substrates with metallization to improve the functioning of the process and to be able to disassemble the bond from the two sides.

The expected characteristics of the glued bonds and the method for measuring them are characterized in particular by a “tensile-shear” test pursuant to the standard ISO 4587.

For a glued structural assembly, a strength between 10 and 20 Mpa can be expected, depending on the adhesives and the substrates.

In this type of test, the fracture surface is an important point: it is preferred in general for the fracture to occur in one of the materials; in this case it is a matter of a cohesive fracture in the adhesive or the substrates, instead of an adhesive failure at an interface.

Actually it is considered that a cohesive fracture indicates that the strength of the bond is limited by the intrinsic performance of the materials used, while an adhesive failure signifies an imperfect gluing process.

As explained above, for detachability it is desirable for the residual strength of the assembly to be as low as possible, and in any case below 1 Mpa. In this case an adhesive fracture is preferred, which makes any later reuse of the substrate easier.

The disassembly is triggered by heating the bond, for a more or less long time and at a more or less high temperature, depending on the adhesives and the additives used.

The tests were made by metallizing a first of the composite elements to be glued on a first side of the bond, and using detachable primer base DGEBA-DETA with added pTSH (para-toluenesulfonyl hydrazide), with the adhesive then used being an adhesive known by the brand name Hysol from the HENKEL Company, and with the reference EA 9395.

In this configuration, the adhesive forms a barrier on the second side of the bond, which avoids metallizing the second of the composite elements to be glued.

Another solution consists of using a detachable primer base DGEBA-Jerramine with added ADA (azodicarbonamide), with the adhesive then used again being Hysol EA 9395.

In the first case, in which the detachability agent is pTSH, activation to obtain detachability, for example, is from 1 to 10 min at 120° C.

In the second case, in which the detachability agent is ADA, activation for 10 to 10 min at 200° C. is suitable.

In every case it is still possible, if the substrates support it, to reduce the activation time by increasing the activation temperature.

According to a first embodiment of the disclosed embodiments, the tightness of a composite is ensured by using a thin metallic layer of aluminum strip, for example, that is glued to the composite prior to the deposition of the detachable primer or of the detachable adhesive to the substrate thus covered. It is also possible to glue the strip already coated with detachable primer, which simplifies the operation.

The following assembly is then obtained: composite/coupling adhesive/metal strip/detachable primer/adhesive/composite.

The detachable primer in particular can be a DGEBA-DETA with added pTSH.

The strength before detachment is conventional, 15 Mpa with failure between the composite and the metal strip.

On the other hand, after activating the ungluing for one minute at 120° C., the residual strength is only 0.7 Mpa, conforming to what was desired.

The failure is also an adhesive failure between the metal strip and the primer with added pTSH, and this solution is accordingly completely in accord with the expected results.

The use of s metal strip to seal the interface with the composite accordingly is compatible with the structural gluing, in other words:
compatible with good adhesion to the substrates,
compatible with the detachable gluing systems,
providing mechanical strength between 10 and 20 Mpa.

Materials other than aluminum could obviously be suitable, with their choice depending only on the use of the glued assemblies, the gluing systems, and the substrates considered.

On the other hand, the use of metal strips is limited by the geometric shape of the surfaces to be assembled, which have to be developable, with the metal strips as starting material having a regular shape in the mathematical sense of the term.

According to a second embodiment of the disclosed embodiments, the solution is improved by a metallic lining to make it compatible with the complex geometries encountered in practice with mechanical parts.

To do this, metallization is provided for by deposition usable for any geometry, and meeting the criteria of good initial adhesion and good detachability.

Accordingly, different metallization technologies were tested, which are described below.

According to a first embodiment, metallic deposition is performed by electroplating.

Plates of composite are lined with nickel on an undercoating of copper by a conventional electroplating method, with the total thickness of the deposition obtained being about a hundred microns.

The test specimens thus treated were assembled by detachable gluing with a Hysol EA 9395 adhesive on a detachable primer based on DGEBA-DETA with added pTSH.

In the initial state, the strength measured was 8 Mpa with failure at the nickel/composite interface, a strength that is still low, however, in the context of structural gluing.

On the other hand, after activation at 120° C., the residual strength was 0.7 Mpa, as desired.

It is thus found that this method of metallization provides a glue joint that is detachable on demand, but it is also found that the adhesion of the lining according to this method is insufficient for a high-strength structural glue joint.

According to a second embodiment, metallization is performed by vapor phase physical deposition, for example by cathodic sputtering.

Cathodic sputtering is a procedure of the PVD type (Physical Vapor Deposition in Anglo-Saxon terminology) using a plasma. A vector gas is introduced into a reduced-pressure chamber, the molecules of gas become ionized, and strike a metal deposition plate called a target under the action of an electric field. Particles of metal are stripped off and are deposited on the substrate, and a coating of metal is created on the surface of the composite. This technique provides for the deposition of a very thin metal layer on the substrate.

Different types of deposits are made by this technology: deposits of aluminum, titanium, and nickel/chromium alloy from 1 to 10 microns thick.

In all of the cases, an initial strength of between 12 and 18 Mpa is obtained with the same adhesive system, and a strength after controlled detachability of between 0.5 and 0.7 Mpa.

The work done showed that the deposition had to be done very carefully with regard to the preparation of the composite material before metallization.

For example, it is known that before PVD it is possible to strip the substrates using neutral or reactive atoms.

This stripping in the context of the disclosed embodiments increases the strength of the bond before activating the ungluing.

Comparisons were made between samples prepared without stripping, with samples stripped on the one hand with argon atoms, and on the other hand by stripping with a mixture of argon and oxygen atoms; all of these samples were then coated with 2 microns of titanium. The table below shows the strengths before activating detachment as a function of the presence or not of stripping and of the type of stripping.

| Stripping | Failure MPa |
|---|---|
| None | 12 |
| Argon alone | 14 |
| Argon + O2 | 18 |

According to a third embodiment, metallization was performed by flame projection.

Flame projection is a simple and inexpensive technique that uses the chemical reaction between oxygen and a gaseous combustion fuel (acetylene, hydrogen) to produce a source of heat. This thermal source creates the flame. The starting material is in the form of a powder or film.

If the starting material is in wire form, the only function of the flame is to melt the material, with this material being projected by compressed air.

In the flame projection method using powder, the particles are injected into the torch, and then are melted and projected by the flame.

The principal advantage of this technique is the wide variety of powders used that thus offer a wide range of solutions.

Two depositions were performed: one of aluminum, the other of nickel/chromium, with high thickness.

The results shown in the table below were all obtained with the same gluing system and aluminum/composite assemblies

| Type of metallization | Shear strength, MPa | Detachability |
|---|---|---|
| Aluminum | 13.5 ± 0.4 | Low residual strength |
| | Composite/metal AF | 80% metal/primer AF |
| NiCr | 11.5 ± 1.9 | Low residual strength |
| | Composite/metal AF | 80% metal/primer AF |

In this table, the abbreviation AF means adhesive fracture.

The residual strength obtained with these tests is close to 1 MPa, while the samples tested were rather rough with an Ra of about 6 microns.

With this technique, the strengths obtained are rather satisfactory, but the rupture surfaces are adhesive at the composite/metal interface. These values approach the strength of structural assemblies, but the criterion of cohesive rupture is not completely satisfied.

As for the detachability after activation, a low residual strength exists and the rupture surfaces are mostly adhesive at the metal/primer interface and cohesive in the primer.

The disclosed embodiments enable the correct functioning of the method of gluing on porous materials that is detachable on activation, while ensuring effective surface sealing of these materials with a lining.

Another advantage of metallization of the glue zones is that the metallic lining can constitute an electrically conductive zone beneath the detachable primer and a resistive conductive pathway capable of activating the detachability of the bond by the passage of an electric current in the metallic lining to heat the bond zone by a Joule effect.

The disclosed embodiments are applicable in the context of the controlled disassembly of composite structures of space launchers, but a number of applications that make use of composite parts assembled by gluing can benefit from it.

In the automobile sector, the use of composite material, particularly for body elements, combined with the increasing interest in assembly by gluing, creates a favorable terrain for the use of the disclosed embodiments.

The wind turbine sector, a large consumer of composites and of structural adhesives, can also profit from this technology to facilitate maintenance and dismantling operations on the installations.

1. Method for detachable gluing of at least one porous substrate with another material by means of at least one layer of detachable adhesive that contains an ungluing additive able to generate gases that disrupt an adhesive bond by gaseous expansion or by gaseous migration to at least one of the interfaces of the layer of detachable adhesive under the action of heat for controlled detachment, wherein a metallic seal lining is applied to the said at least one substrate prior to the gluing.

2. Method for detachable gluing of at least one porous substrate pursuant to claim 1 for which said layer of detachable adhesive contains a layer of a detachable primer and a layer of adhesive.

3. Method for detachable gluing of at least one porous substrate pursuant to claim 1 for which the metallic lining is produced by means of a metal strip glued to the said at least one substrate by means of a composite/metal coupling adhesive.

4. Method for detachable gluing of at least one porous substrate pursuant to claim 1 for which the metallic lining is produced by means of a metal strip glued to the said at least one substrate by fusing them together.

5. Method for detachable gluing of at least one porous substrate pursuant to claim 3 for which the metal strip is an aluminum strip.

6. Method for detachable gluing of at least one porous substrate pursuant to claim 3 for which the metal strip is coated with the layer of detachable adhesive prior to its application to the said at least one substrate.

7. Method for detachable gluing of at least one porous substrate pursuant to claim 1 for which the metallic lining is produced by metal deposition.

8. Method for detachable gluing of at least one porous substrate pursuant to claim 7 for which the metal deposition is performed by electroplating.

9. Method for detachable gluing of at least one porous substrate pursuant to claim 8 for which a layer of copper is deposited on the substrate.

10. Method for detachable gluing of at least one porous substrate pursuant to claim 9 for which the metal lining is concluded by depositing a layer of nickel on the layer of copper.

11. Method for detachable gluing of at least one porous substrate pursuant to claim 7 for which the metal deposition is performed by a technique of physical vapor phase deposition of a metal.

12. Method for detachable gluing of at least one porous substrate pursuant to claim 11 for which the metal is chosen from aluminum, titanium, and a nickel/chromium alloy.

13. Method for detachable gluing of at least one porous substrate pursuant to claim 11 for which the metal lining is produced by the deposition of a layer of metal from 1 to 10 microns in thickness.

14. Method for detachable gluing of at least one porous substrate pursuant to claim 11 for which the metal lining is produced by the deposition of a layer of titanium from 1 to 3 microns in thickness.

15. Method for detachable gluing of at least one porous substrate pursuant to claim 7 for which the metal deposition is performed by flame projection metallization.

16. Method for detachable gluing of at least one porous substrate pursuant to claim 15 for which the metal is chosen from aluminum, titanium, and a nickel/chromium alloy.

17. Method for detachable gluing of at least one porous substrate pursuant to claim 7 for which the substrate is stripped prior to the deposition.

18. Method for detachable gluing of at least one porous substrate pursuant to claim 17 for which the stripping is done with argon atoms.

19. Method for detachable gluing of at least one porous substrate pursuant to claim 17 for which the stripping is done with a mixture of argon and oxygen atoms.

20. Method for detachable gluing of at least one porous substrate pursuant to claim 7 for which the surface of the metallic lining is polished after deposition and before application of the detachable adhesive and gluing so as to reduce the roughness Ra of the lining.

21. Method for detachable gluing of at least one porous substrate pursuant to claim 20 for which at least either the thickness of the metallic lining or roughness of the metallic lining is adapted to obtain a breaking strength between 10 and 20 MPa before the detachment action and a breaking strength of less than 1 Mpa after the detachment action.

22. Detachable assembly of at least one porous substrate made by means of a detachable gluing procedure pursuant to claim 21 for which the strength of the assembly before the detachment action is greater than 15 Mpa with cohesive rupture between the substrate and the lining, and the residual strength after the detachment action is below 0.8 Mpa.

23. Detachable assembly of at least one porous substrate made by means of a detachable gluing procedure pursuant to claim 3, wherein, with the substrates being composite, it contains the following: a first composite substrate, a composite/metal coupling adhesive, a metallic lining, a layer of detachable primer, a layer of adhesive, and a second substrate.

24. Detachable assembly of at least one porous substrate made by means of a detachable gluing procedure pursuant to claim 1, wherein the metallic lining makes an electrically conductive zone beneath the detachable primer and constitutes a conductive resistive pathway able to control the detachability of the bond by the passage of an electric current in the metallic lining to heat the bonding zone by a Joule effect.
